(19) United States
(12) Patent Application Publication
(10) Pub. No.: US 2018/0143991 A1
(43) Pub. Date: May 24, 2018

(54) ELECTRONIC DEVICE AND INFORMATION PROCESSING METHOD

(71) Applicant: KYOCERA Document Solutions Inc., Osaka (JP)

(72) Inventor: Kosuke TAKI, Osaka (JP)

(73) Assignee: KYOCERA Document Solutions Inc., Osaka (JP)

(21) Appl. No.: 15/812,237

(22) Filed: Nov. 14, 2017

(30) Foreign Application Priority Data
Nov. 18, 2016 (JP) 2016-225478

(51) Int. Cl. G06F 17/30; G06F 3/0484

(52) U.S. Cl. CPC G06F 17/30126; G06F 17/30221; G06F 3/0484

(57) ABSTRACT

An electronic device includes a display section, a first control section, a first acceptance section, a second acceptance section, a determination section, and a retrieval section. The first control section allows a window screen on the display section to display a folder configuration, and a filename of a file saved in each of the folders. The first acceptance section accepts entry of a retrieval keyword. The second acceptance section accepts entry designating a folder on which to perform the file retrieval. The determination section determines, based on the folder of which the second acceptance section accepted the designation, a range of hierarchies of folders on which to perform the file retrieval. The retrieval section retrieves the file containing, in the filename, the retrieval keyword accepted by the first acceptance section, the retrieval being performed on the folders included in the range of hierarchies determined by the determination section.

### INCORPORATION BY REFERENCE

This application claims priority to Japanese Patent Application No. 2016-225478 filed on Nov. 18, 2016, the entire contents of which are incorporated by reference herein.

### BACKGROUND

The present disclosure relates to electronic devices that retrieve a file containing a keyword, and information processing methods.

In a general file retrieval method performed by an electronic device, a user displays a folder likely to include a desired file, enters a keyword contained in, for example, a filename of the desired file, and performs file retrieval. Files having filenames that include the keyword are displayed as a retrieval result.

In such the file retrieval, a retrieval range covers only the folders displayed in a display section. In a case where the user desires to set, as the retrieval range, folders in a hierarchy different from the folders being displayed, the user has to separately open the folders in the different hierarchy to perform the retrieval. This work is troublesome for the user.

There is a method of performing file retrieval by easy operation without burdening a user, which is achieved by making it possible to perform retrieval based on a preset retrieval criterion (situation), i.e., a setting retrieval method.

### SUMMARY

A technique improved over the aforementioned technique is proposed as one aspect of the present disclosure.

An electronic device according to an aspect of the present disclosure includes a display section, a first control section, a first acceptance section, a second acceptance section, a determination section, and a retrieval section.

The first control section allows the display section to display, in a window screen on the display section, a folder configuration and a filename of a file saved in each of the folders.

The first acceptance section accepts entry of a retrieval keyword.

The second acceptance section accepts entry designating a folder on which to perform the file retrieval.

The determination section determines, based on the folder of which the second acceptance section accepted the designation, a range of hierarchies of folders on which to perform the file retrieval.

The retrieval section retrieves the file containing, in the filename, the retrieval keyword accepted by the first acceptance section, the retrieval being performed on the folders included in the range of the hierarchies determined by the determination section.

### BRIEF DESCRIPTION OF THE DRAWINGS

FIG. 1 is a block diagram showing an internal configuration of an information processing device which is one example of an electronic device.

FIG. 2 is a flowchart showing a flow of file retrieval processing.

FIG. 3 is a flowchart showing a flow of the file retrieval processing.

FIG. 4 is a view showing a display example of a window screen.

FIG. 5 is a view showing a display example of the window screen.

FIG. 6 is a view showing a display example of the window screen.

### DETAILED DESCRIPTION

Hereinafter, a description will be given of an electronic device, such as an information processing device and an image forming apparatus, and an information processing method according to one embodiment as one aspect of the present disclosure with reference to the drawings.

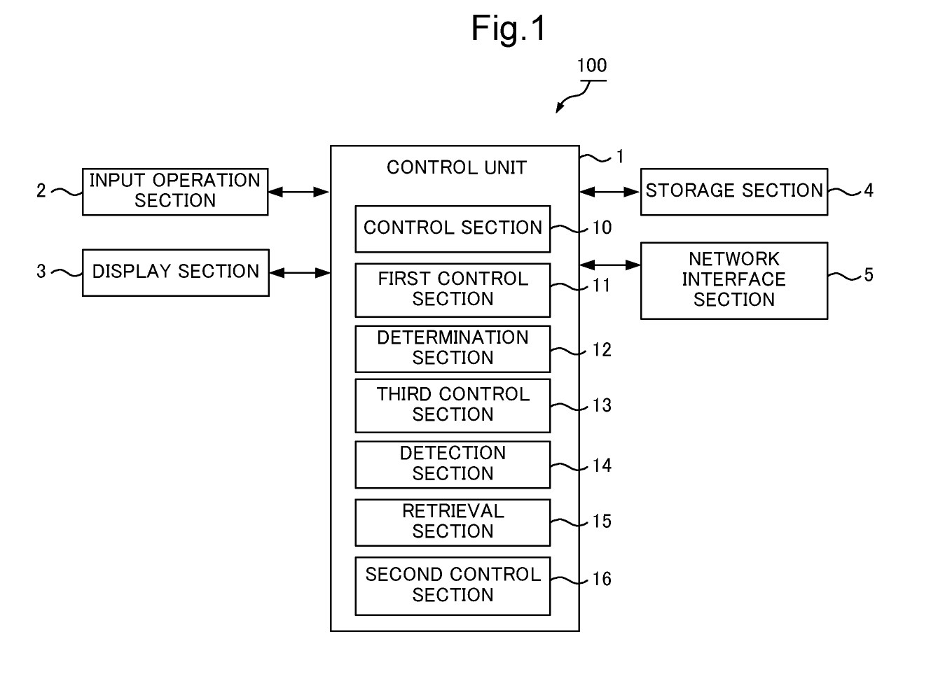

FIG. 1 is a block diagram showing an internal configuration of an information processing device 100 as one example of the electronic device according to the one embodiment of the disclosure. The information processing device 100 of the present embodiment is, for example, a computer. The information processing device 100 includes a control unit 1, an input operation section 2, a display section 3, a storage section 4, a network interface section 5, and so on.

The input operation section 2 is a pointing device such as a keyboard and a mouse, and transmits to the control unit 1 an electric signal in accordance with input operation. The input operation section 2 corresponds to a first acceptance section, a second acceptance section, and a third acceptance section.

The display section 3 is formed of a liquid crystal display (LCD) or an organic light-emitting diode (OLED) display.

The storage section 4 is a large-capacity storage device having a solid state drive (SSD) or a hard disk drive (HDD), both storing data, various kinds of programs and so on.

The network interface section 5 is an interface circuit for transmitting and receiving data to and from an external device via a network.

The control unit 1 includes a processor, a random access memory (RAM), a read only memory (ROM), and an exclusive hardware circuit. The processor is, for example, a central processing unit (CPU), an application specific integrated circuit (ASIC), and a microprocessor unit (MPU). The control unit 1 includes a control section 10, a first control section 11, a determination section 12, a third control section 13, a detection section 14, a retrieval section 15, and a second control section 16.

The control unit 1 acts as the control section 10, the first control section 11, the determination section 12, the third control section 13, the detection section 14, the retrieval section 15, and the second control section 16 based on operation of the processor according to a control program stored in an HDD 92. However, each of the aforesaid sections may be constituted in the form of a hardware circuit instead of the operation by the control unit 1 in accordance with the control program. This also applies to other embodiments, unless otherwise specifically noted.

The control section 10 controls the overall operation of the information processing device 100.

The first control section 11 allocates, as a window screen, a square display area within the display section 3, and allows the display section 3 to display, in the window screen, images representing hierarchical structures of folders and images representing filenames of the files saved in each of the folders, both of the images being stored in the storage section 4.

When a retrieval keyword to be used for file retrieval is entered, the determination section 12 determines a range of hierarchies of the folders on which to perform the file retrieval; the determination is based on a hierarchy to which a folder being selected belongs. The folder being selected may be a folder that the control unit 1 has determined by a predetermined method or may be a folder that a user has arbitrarily designated. In this embodiment, descriptions are given in a case where the determination section 12 lists the folders on which to perform the file retrieval. However, it should be noted that it is not intended to limit the embodiments of the present disclosure to the case.

When the input operation section 2 accepts entries of a special character string along with the retrieval keyword, the determination section 12 determines a retrieval range based on the hierarchy indicated by the entered special character string and the folder being selected. The input operation section 2 is being display on the display section 3 by a mouse pointer which is a part of the input operation section 2.

The special character string is instruction symbols that the user enters along with the retrieval keyword in order to designate a hierarchy other than the hierarchy of the folder being selected, and to target for the file retrieval. For example, in a case where the retrieval keyword is “aaa.txt”, and the user desires to perform retrieval from the hierarchy that one level higher than the hierarchy of the folder being selected, the user enters “aaa.txt-u1” in the input operation section 2. The just mentioned special character string “-u1” is one example of the instruction symbols that target, to the retrieval, the one level higher hierarchy. Other examples of the instruction symbols are: “-u2” for retrieving from the two levels higher hierarchs; and “-u3” for retrieving from the three levels higher hierarchy. The user enters in the input operation section 2 the instruction symbols corresponding to the hierarchy to which the user desires to target for the retrieval. Namely, the user can set the instruction symbols by adding, to after “-u”, the number of hierarchies that the user desires to go up. The user then enters the set instruction symbols in the input operation section 2. It should be noted that the acceptance by the input operation section 2 of the file retrieval range is not limited to the above-described acceptance using the special character string. When the user designates, in the image representing the hierarchy of the folders displayed in the display section 3, a certain folder by operating the mouse pointer, which is a part of the input operation section 2, the input operation section 2 may be arranged to accept the designation as a special character string instruction that causes the hierarchy one level higher than the hierarchy of the certain folder to be the retrieval target.

Conversely, in a case where the user desires to perform the file retrieval from the hierarchy one level lower than the hierarchy of the folder being selected, the user enters “aaa.txt-d1” in the input operation section 2. The just mentioned special character string “-d1” represents the one level lower hierarchy. To perform the file retrieval from the two levels lower hierarchy, “-d2” is entered. Namely, the number of hierarchies that the user desires to go down is to be added to after “-d”. The above-described way of accepting the entry of the special character string along with the retrieval keyword and the way in which the determination section 12 determines the retrieval range based on the special character string enable the user to easily perform the retrieval on other hierarchies different from the hierarchy of the folder being selected.

It should be noted here that the description method of the special character string detailed in this embodiment is merely an example and the special character string may be described by different ways.

The third control section 13 allows the display section 3 to display, in the window screen thereon, at least either one of capacity and the number of files of each of the folders displayed in the window screen.

In a case where the user selects a certain folder in order to perform the file retrieval, the detection section 14 detects a similar folder that has a name similar to the name of the certain folder. There, the detection is performed on the folders other than the certain folder to which the determination section 12 has determined as the retrieval range. The first control section 11 allows the display section 3 to display, in the window screen thereon, the similar folder having been detected by the detection section 14. In a case where the input operation section 2 accepts the similar folder as the folder to perform the file retrieval, the retrieval section 15 targets the similar folder to the file retrieval. In contrast, in a case where the input operation section 2 accepts the similar folder as the folder not to perform the file retrieval, the retrieval section 15 does not target the similar folder to the file retrieval. Accordingly, the user can easily detect related folders on which further file retrieval should be performed in order to find the desired file. This can prevent retrieval omission.

The retrieval section 15 retrieves, from a file group included in the folders within the retrieval range determined by the determination section 12, the file containing the retrieval keyword having been entered in the input operation section 2 in any one of the filename, attribute information, entity data, and so on. The retrieval section 15 may be arranged so as to cause only one or two among the filename, attribute information, entity data, and so on to be the subject for the retrieval on whether the retrieval keyword is included.

The second control section 16 allows the display section 3 to display, within the window screen thereon, an image representing the progress of the retrieval (progression status) of the folders that the retrieval section 15 is performing the retrieval. For example, the second control section 16 allows the display section 3 to display an image representing a progress bar, so that the user can visually and intuitively recognize a percentage of completeness of retrieval processing.

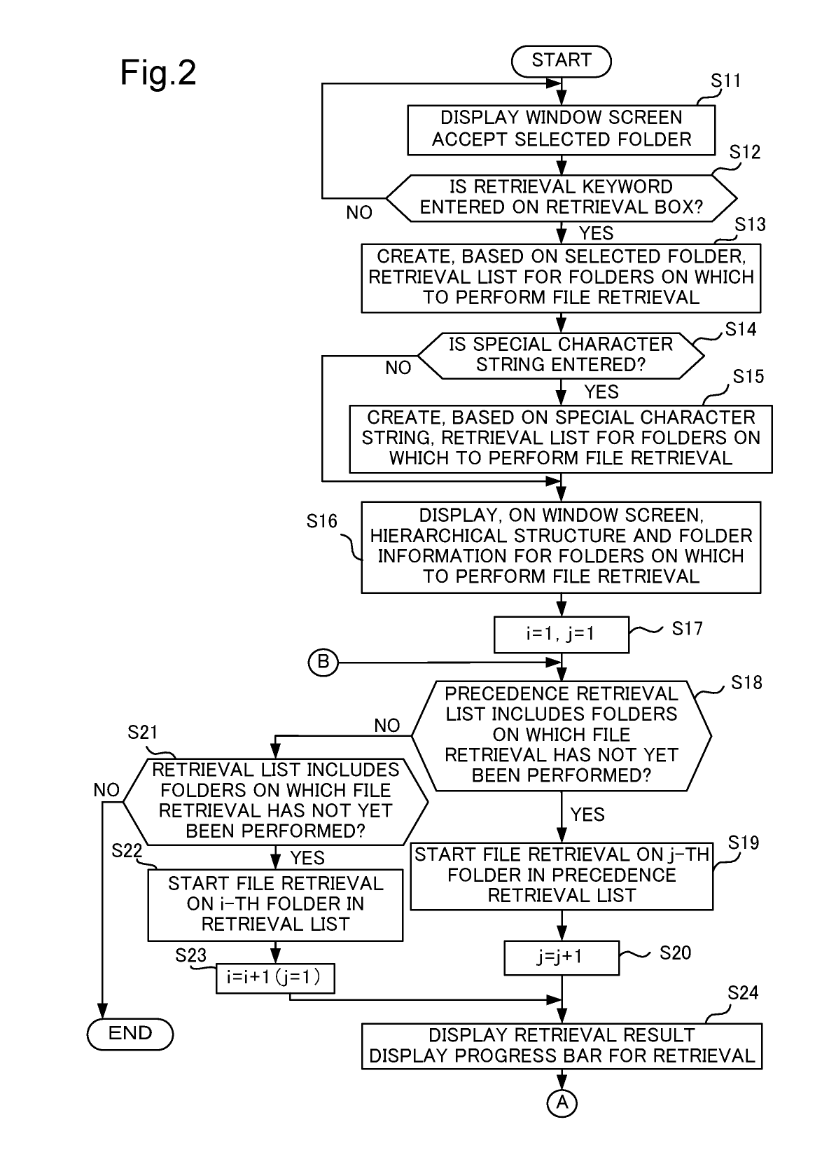

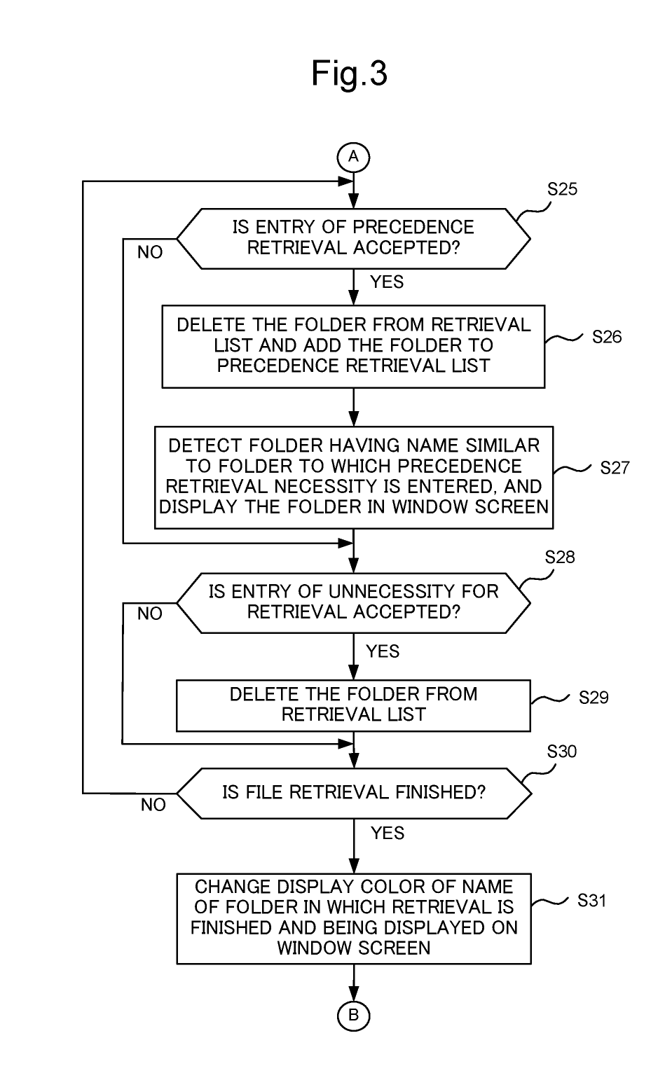

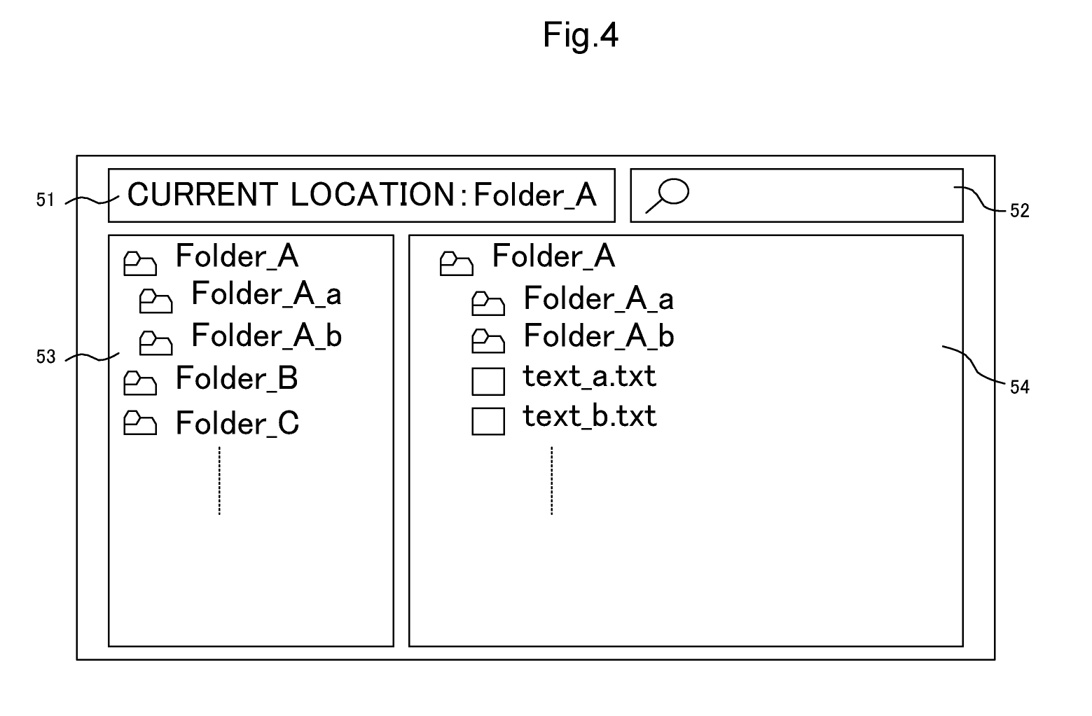

Hereinafter describes file retrieval processing of the present embodiment. FIG. 2 and FIG. 3 are flowcharts showing a flow of the file retrieval processing of the present embodiment. FIG. 4 to FIG. 6 are views showing a display example of the window screen that the first control section 11 allows the display section 3 to display. The flow of the file retrieval processing of the present embodiment will be detailed with reference to FIG. 2 to FIG. 6.

Firstly, the first control section 11 allows the display section 3 to display the window screen (step S11: first control step). The window screen will be detailed with reference to FIG. 4. The hierarchical structures of folders and filenames of the files saved in each of the folders, both being stored in the storage section 4, are displayed on the window screen. Specifically, the name of the folder being selected is displayed on an area 51; the hierarchical structure below the hierarchy to which the folder being selected belongs is displayed on an area 53; and the hierarchical structure of the folder being selected and the saved filenames are displayed on an area 54.

The user operates the input operation section 2 and enters, on the area 51, the desired folder to be display on the window screen. In accordance with the entry, the input operation section 2 accepts the selection of the folder (step S11: second acceptance step). The user can directly enter the folder name on the area 51 by using the keyboard which is as the input operation section 2. Also, by using a pointing device such as a mouse, the user can select, from the folders displayed on the area 53, an image representing the folder that the user is desired to display on the window screen. FIG. 4 illustrates a state where the folder named “Folder_A” is being selected by the user. In the state, the first control section 11 is allowing the display section 3 to display, in the area 54 thereon, the hierarchical structure in “Folder_A” (the hierarchical structure of the folder) and the filenames saved in “Folder_A”.

An area 52 on the window screen is: displayed on the display section 3 as the first control section 11 performs display control; and is a retrieval box on which the retrieval keyword is entered and displayed. The user enters the retrieval keyword on the area 52 by using, for example, the keyboard that is one example of the input operation section 2.

Upon entry of the retrieval keyword on the area 52 (YES in step S12: first acceptance step), the determination section 12 determines the retrieval range based on the hierarchy to which the folder being currently selected belongs, and creates a retrieval list in which the folders to be in the retrieval range are listed up (step S13: determination step). In a case where the special character string is entered along with the retrieval keyword on the area 52 (YES in step S14), the determination section 12 determines, in accordance with the hierarchy that the folder being currently selected belongs to and a content indicated by the special character string, the folders to be in the retrieval range, and creates the retrieval list in which the folders to be in the retrieval range are listed up (step S15).

The first control section 11 then allows the display section 3 to display, on the area 54 of the window screen, the hierarchical structure of the folders in the retrieval range determined by the determination section 12 (hierarchical structure of the folders shown by the retrieval list).

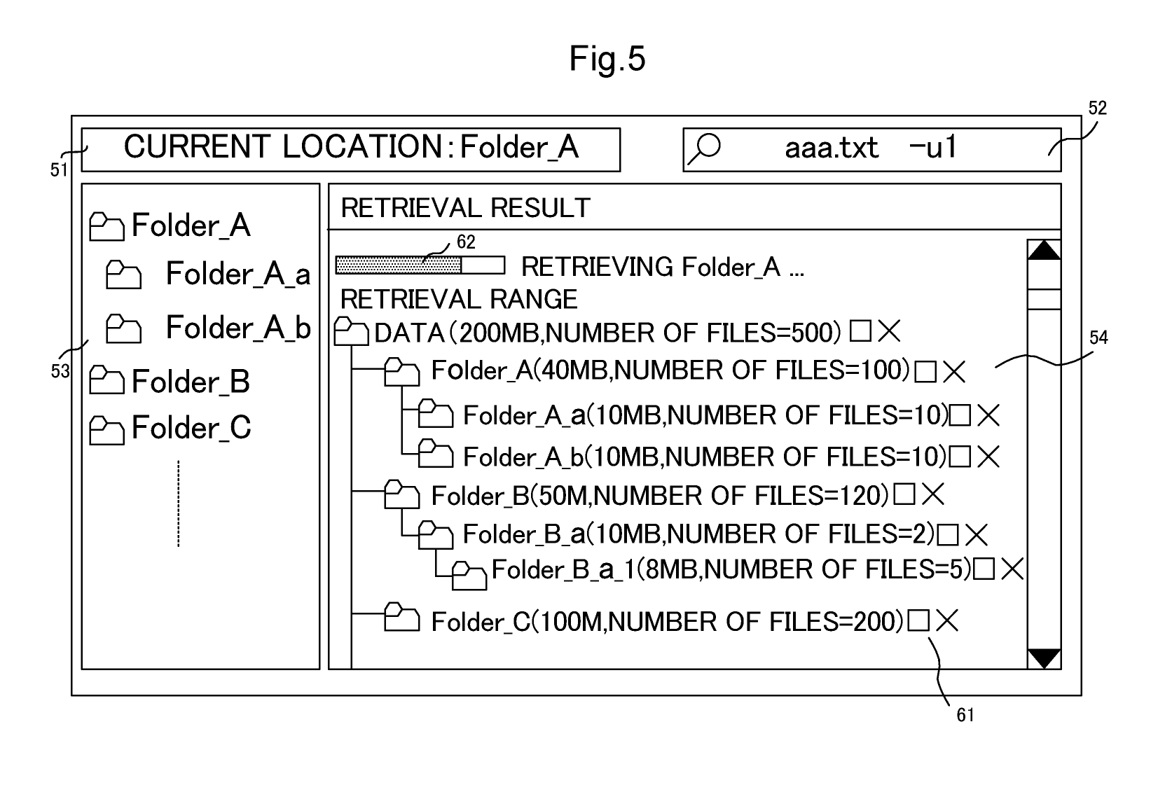

FIG. 5 is the view showing one example of the window screen when the retrieval keyword “aaa.txt-u1” is entered in the area 52. The special character string “-u1” is entered along with the retrieval keyword, so that the determination section 12 determines, as the retrieval range, the folders included in hierarchies lower than one level higher hierarchy of “Folder_A”, which is the folder currently being selected, and adds all the folders included in the hierarchies lower than the one level higher hierarchy of “Folder_A” to the retrieval list. Furthermore, the first control section 11 allows the display section 3 to display, in the area 54 of the window screen, the hierarchical structure starting from the one level higher hierarchy of “Folder_A” as the retrieval range (step S16). In other words, the first control section 11 allows the display section 3 to display, in the area 54 of the window screen, only the folders to be in the retrieval range. The retrieval section 15 performs the file retrieval only on the folders displayed in the display section 3.

At this time, with respect to each of the folders displayed in the area 54, the third control section 13 allows the display section 3 to display, in the area 54 of the window screen, at least either one of capacity and the number of files of each of the folders. FIG. 5 illustrates the case where both of the capacity and the number of files of each of the folders are being displayed as folder information.

Then, the first control section 11 allows the display section 3 to respectively display a check box for each of the folders. This display control enables the user to arbitrarily perform selection of the folders to be retrieved in order of priority, and selection of the folders to be deleted from the retrieval range. The selection is performed on the folders displayed on the area 54 of the window screen having been determined as the retrieval range by the determination section 12.

A display example of the check box is shown in FIG. 5 by the reference numeral 61. For example, when the user operates the input operation section 2 and enters a check on the square shaped check box, the determination section 12 adds the checked folder to a precedence retrieval list and the retrieval section 15 preferentially retrieve the folder. On the other hand, when the user operates the input operation section 2 and selects the mark “×”, the determination section 12 deletes the marked folder from the retrieval list. That is, the determination section 12 excludes the folder in which “×” is selected from the retrieval target.

In this embodiment, the third control section 13 allows the display section 3 to display the capacity and the number of files saved in each of the folders. Accordingly, when the user desires to end the retrieval processing in a short time, the user can exclude the folder with large capacity from the retrieval target by selecting the mark “×” to delete the folder from the retrieval list. By enabling the user to select the folders in the retrieval range in this manner, the file retrieval can be performed efficiently.

As a next step, the first control section 11 substitutes 1 into variables i and j (step S17). Each of i and j is an integer equals to or larger than 0. The variable i represents a folder number registered in the retrieval list and the variable j represents a folder number registered in the precedence retrieval list.

In a case where the precedence retrieval list includes folders on which the file retrieval has not yet been performed (NO in step S18) and a folder on which the file retrieval has not yet been performed belongs to the retrieval list (YES in step S21), the retrieval section 15 starts the retrieval on the i-th folder in the retrieval list (step S22: retrieval step), and the first control section 11 adds 1 to the variable i. In a case where the first control section 11 starts the file retrieval on the retrieval list after finishing the file retrieval on the entire precedence retrieval list, there may be a case in which a folder is added again to the precedence retrieval list, so that the first control section 11 resets the variable j by substituting 1 into the variable j (step S23).

The first control section 11 then allows the display section 3 to display, within the window screen thereon at any time, the filename having been retrieved by the retrieval section 15. The second control section 16 allows the display section 3 to display, within the window screen thereon, a progress bar 62 representing the progression status of the retrieval processing under the execution by the retrieval section 15 (step S24).

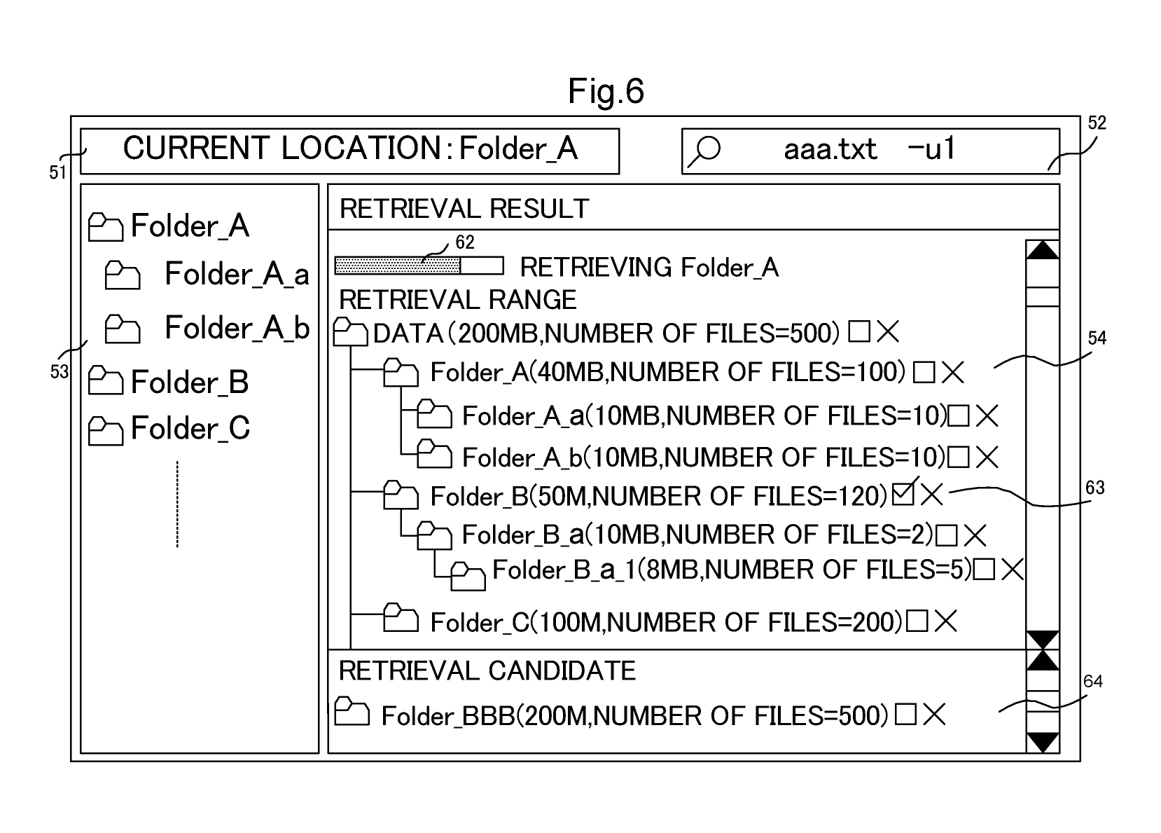

In a case where the selection on the precedence retrieval is entered on the check box by the user's operation on the input operation section 2 (YES in step S25), the determination section 12 deletes the respective folder from the retrieval list and adds the folder to the precedence retrieval list. In other words, the folder is moved from the normal retrieval list to the precedence retrieval list (step S26). FIG. 6 shows the folder named “Folder_B” when the selection is entered on the check box 63. The retrieval section 15 performs the file retrieval firstly from the folders registered in the precedence retrieval list. Accordingly, the user can preferentially retrieve the desired folder.

Subsequently, the detection section 14 detects, from the folders having been determined as not in the file retrieval range by the determination section 12 (namely, the folders not registered in either of the retrieval list and the precedence retrieval list), the similar folder that has the name similar to the name of the folder having been selected as to perform the precedence retrieval. In a case where the similar folder is detected, the first control section 11 allows the display section 3 to display, in the window screen thereon, the similar folder (step S27).

As shown in FIG. 6, the detection section 14 detects, for example, the similar folder similar to the folder name “Folder_B”, from the folders having been determined as not in the file retrieval range by the determination section 12. When “Folder_BBB” is detected as a detection result, the first control section 11 allows the display section 3 to display, in an area 64 of the window screen thereon, the folder “Folder_BBB”, its folder information, and the check box. As seen from the above, the detection section 14 detects, from an outside of the retrieval range, the similar folder that has the name similar to the name of the folder having been designated to perform the precedence retrieval; and the first control section 11 presents the detection result in the window screen. This provides an effect of notifying the user of missing of the folder designation and prevents the retrieval omission.

On the other hand, when the user operates the input operation section 2 and inputs a designation of a folder on which the file retrieval is unnecessary (YES in step S28), the determination section 12 deletes the folder from the retrieval list or the precedence retrieval list (step S29); the designation is made on each of the folders to which the first control section 11 is allowing the display section 3 to display on the area 64 of the window screen. This arrangement omits file retrieval to be performed on the unnecessary folder and the time required for the retrieval processing can be shortened. The first control section 11 may be arranged to delete, from the window screen, the display of the folders to which the unnecessity for the file retrieval has been entered. Also, the first control section 11 may be arranged to allow the display section 3 to display, in the window screen thereon, the folder name of the folder to be retrieved in a display mode different from the folder name of the folder not to be retrieved by changing the displaying color to, for example, red, while the folder names are kept displayed. For example, as the first control section 11 allows the display section 3 to keep displaying, in the window screen thereon, the folder name not to be retrieved with the red character, the user can recognize that the file retrieval is not to be performed on that folder. In addition, by operating the input operation section 2 and entering the check on the check box of the folder that the user desires to restore as the retrieval target, the user can designate the folder as the precedence retrieval.

In a case where the file retrieval by the retrieval section 15 is unfinished (NO in step S30), processing shifts to step S25. In a case where the file retrieval by the retrieval section 15 is finished (yes in step s30), the first control section 11 changes a display color of the name of the folder in which retrieval is finished and being displayed on the window screen to, for example, blue (step S31). In such the manner, the first control section 11 allows the display section 3 to display the image representing the folder in which the file retrieval has finished in a different display mode from the display mode of the folder in which the file retrieval has not finished. Processing shifts to step S18 afterwards.

Returning to step S18, in a case where the user has designated a folder on which to perform the precedence retrieval by operating the check box displayed on the window screen during the file retrieval that the retrieval section 15 had previously performed, the folder has been registered in the precedence retrieval list by the determination section 12. Therefore, in a case where the precedence retrieval list includes the folder on which the file retrieval has not yet been performed (YES in step S18), the retrieval section 15 starts the retrieval within the j-th folder in the precedence retrieval list (step S19: retrieval step), and the first control section 11 adds 1 to the variable j (step S20).

In a case where neither the retrieval list nor the precedence retrieval list includes folders on which the file retrieval has not yet been performed, the file retrieval processing is terminated (NO in step S18 and NO in step S21).

The information processing device 100 of the present embodiment functions as a server such as an image forming apparatus. Accordingly, a device at the server side (i.e., the information processing device 100) performs the file retrieval and transmits the retrieval result file to the image forming apparatus, thereby enabling the user to instantly print out the file obtained from the retrieval result through the image forming apparatus.

As thus far described, the input operation section 2 accepts, along with the retrieval keyword, the entry of the special character string for designating the hierarchies of the folders to be the retrieval range. Therefore, even a hierarchy other than the hierarchy to which the folder being currently selected belongs can be easily designated as the retrieval range.

Furthermore, the first control section 11 allows the display section 3 to respectively display the check box for each of the folders being displayed on the window screen as the retrieval range, and the user operates the input operation section 2 and enters the check on the check box. Thus, the first control section 11 can cause the folder with the selected check box to be the precedence retrieval target, and can exclude, from the retrieval target, the folder with the check box on which the check is cleared. Accordingly, the user can customize the target of the retrieval so that only the desired folders are in the file retrieval range. For example, by setting a large folder of size to be excluded from the retrieval target, the user can shorten the time required for the retrieval processing.

Additionally, the third control section 13 allows the display section 3 to display, in the window screen thereon, at least one of the capacity and the number of files of each of the folders. Therefore, in a case where the user desires to finish the file retrieval quickly, the user can take an action such as excluding the large folder of size from the retrieval target.

Also, the retrieval omission can be prevented as the detection section 14 detects, from the outside of the retrieval range, the similar folder that has the name similar to the name of the folder having been designated as to perform the precedence retrieval.

In a general retrieval method, that is, in a setting retrieval method, a complicated retrieval criterion must be set in advance. Moreover, the setting retrieval method is the method difficult to perform for the user who is unwilling to set the retrieval criterion. Therefore, a method has been hoped in which the user can easily change the folders on which to perform the retrieval without the entry of the special retrieval criterion is required.

The information processing device, which is one example of the electric device, according to the present disclosure can improve the usability of the file retrieval as the folders in the hierarchies different from the hierarchy of the folder being displayed are arranged so as to be easily selectable as the retrieval range.

In general, a hierarchical structure displayed on a window screen is hierarchies lower than the hierarchy having been determined by a preset method at an information processing device side, or hierarchies lower than the hierarchy of the folder which a user arbitrary selected belongs to. Also in a case where a file retrieval is performed with entry of a retrieval keyword, the folders exist in lower hierarchies are to be in a retrieval range.

In contrast, in the information processing device, which is one example of an electronic device, according to this embodiment, when the second acceptance section accepts the designation on the folders on which to perform the file retrieval, the determination section determines the hierarchy of the folders on which to perform the file retrieval based on the accepted designation. Therefore, the information processing device according to this embodiment is capable of easily changing the hierarchy of the folders on which to perform the file retrieval.

In addition, although the above embodiment is described taking the computer as an example of the information processing device, which is one example of the electronic device, according to an embodiment of the present disclosure, the example is merely illustrative. The electronic device according to the present disclosure may be other devices, such as an image forming apparatus, further including an image forming section that forms an image on a recording medium.

While the present disclosure has been described in detail with reference to the embodiments thereof, it would be apparent to those skilled in the art the various changes and modifications may be made therein within the scope defined by the appended claims.

What is claimed is;:

1. An electronic device that performs file retrieval on folders each having a hierarchical structure, the electronic device comprising:
a display section;
a first control section that allows the display section to display, in a window screen on the display section, a folder configuration and a filename of a file saved in each of the folders;
a first acceptance section that accepts entry of a retrieval keyword;
a second acceptance section that accepts entry designating a folder on which to perform the file retrieval;
a determination section that determines, based on the folder of which the second acceptance section accepted the designation, a range of hierarchies of folders on which to perform the file retrieval; and
a retrieval section that retrieves the file containing, in the filename, the retrieval keyword accepted by the first acceptance section, the retrieval being performed on the folders included in the range of the hierarchies determined by the determination section.

2. The electronic device according to claim 1, wherein the retrieval section targets only the folders being displayed in the display section to perform the file retrieval.

3. The electronic device according to claim 1, wherein
the second acceptance section accepts entry of a special character string for designating the hierarchies of the folders to perform the file retrieval,
the determination section determines, based on the hierarchies indicated by the special character string accepted by the second acceptance section, the range of the hierarchies of the folders on which to perform the file retrieval, and
the retrieval section retrieves the file containing, in the filename, the retrieval keyword accepted by the first acceptance section, the retrieval being performed on the folders included in the range determined by the determination section.

4. The electronic device according to claim 2, wherein the first control section allows the display section to display, in the window screen thereon, the hierarchical structure with respect to the range of the hierarchies of the folders determined by the determination section.

5. The electronic device according to claim 2,
further comprising a third acceptance section that accepts, for the folders displayed on the window screen by the first control section, entry on whether or not to retrieve the file containing the retrieval keyword, wherein
the retrieval section performs the file retrieval on the folder that the third acceptance section has accepted as to perform the file retrieval, and does not perform the file retrieval on the folder that the third acceptance section has accepted as not to perform the file retrieval.

6. The electronic device according to claim 5,
further comprising a detection section that detects a similar folder having a folder name similar to a name of the folder on which the third acceptance section has accepted the entry indicating that the file retrieval is to be performed, the detection being performed on the folders other than the folders on which the determination section determined to perform the file retrieval, wherein
the first control section allows the display section to further display, in the window screen thereon, the detected similar folder, and
in a case where the third acceptance section accepts the similar folder as to perform the file retrieval, the retrieval section targets the similar folder to the file retrieval, and in a case where the third acceptance section accepts the similar folder as not to perform the file retrieval, the retrieval section does not target the similar folder to the file retrieval.

7. The electronic device according to claim 2, further comprising a second control section that allows the display section to display, in the window screen thereon, progression status of the retrieval when the retrieval section is performing the file retrieval.

8. The electronic device according to claim 2, further comprising a third control section that allows the display section to display, in the window screen thereon, at least either one of capacity and a number of files of each of the folders, which are the folders that the first control section has allowed the display section to display in the window screen thereon.

9. The electronic device according to claim 2, wherein the first control section allows the display section to display, in the window screen thereon, names of the folders on which the retrieval section has finished the file retrieval in display mode different from names of the folders on which the retrieval section has not finished the file retrieval.

10. An information processing method for performing file retrieval on folders each having a hierarchical structure, the information processing method including:
a first control step of allowing the display section to display, in a window screen on the display section, a folder configuration and a filename of a file saved in each of the folders;
a first acceptance step of accepting entry of a retrieval keyword;
a second acceptance step of accepting entry designating a folder on which to perform the file retrieval;
a determination step of determining, based on the folder of which the second acceptance section accepted the designation, a range of hierarchies of folders on which to perform the file retrieval; and
a retrieval step of retrieving the file containing, in the filename, the retrieval keyword accepted by the first acceptance section, the retrieval being performed on the folders included in the range of the hierarchies determined by the determination section.
